(19) United States
(12) Patent Application Publication
(10) Pub. No.: US 2024/0430186 A1
(43) Pub. Date: Dec. 26, 2024

(54) COMMUNICATION DEVICE, RELAY DEVICE, AND COMMUNICATION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Kazuyuki INOUE, Yokkaichi-shi, Mie (JP); Tadashi MATSUMOTO, Yokkaichi-shi, Mie (JP); Kazuki KITAGAWA, Yokkaichi-shi, Mie (JP); Yojiro SUYAMA, Osaka-shi, Osaka (JP); Tatsuya IZUMI, Osaka-shi, Osaka (JP); Hideyuki TANAKA, Osaka-shi, Osaka (JP)

(21) Appl. No.: 18/575,124

(22) PCT Filed: Jun. 13, 2022
(86) PCT No.: PCT/JP2022/023625

§ 371 Date: Dec. 28, 2023

(30) Foreign Application Priority Data
Jul. 2, 2021 (JP) 2021-111014

(51) Int. Cl. H04L 43/0852; H04L 67/12

(52) U.S. Cl. CPC H04L 43/0852; H04L 67/12

(57) ABSTRACT

A communication device transmits data to a relay device for transmitting received data. The communication device includes a processing unit that performs processing. The processing unit gives an instruction for data transmission to the relay device, and acquires a transmission delay time from the instruction for data transmission to the transmission of the data. The processing unit acquires a determination delay time from the reception of the data by the relay device to a determination point in time at which whether or not to transmit the received data is determined. The processing unit calculates an entire period from the instruction for data transmission to the determination point in time based on the acquired transmission delay time and determination delay time.

### CROSS-REFERENCE TO RELATED APPLICATIONS

This application is the U.S. national stage of PCT/JP2022/023625 filed on Jun. 13, 2022, which claims priority of Japanese Patent Application No. JP 2021-111014 filed on Jul. 2, 2021, the contents of which are incorporated herein.

### TECHNICAL FIELD

The present disclosure relates to a communication device, a relay device, and a communication method.

### BACKGROUND

International Publication No. 2020/136843 discloses a communication system in which a communication device transmits data to another communication device through a relay device. The communication device transmits priority data that needs to reach another communication device in a short period. Upon receiving the priority data from the communication device, the relay device determines whether or not to transmit the received priority data. A permitted period during which transmission of priority data is permitted and a prohibited period during which transmission of priority data is prohibited are alternately set repeatedly. The relay device transmits the received priority data during the permitted period when the determination point in time for determining whether or not to transmit the priority data belongs to the permitted period.

The total period of the permitted period and the prohibited period is fixed. The permitted period and the prohibited period form one cycle. The relay device adjusts the start point in time or length of the permitted period when there is priority data whose determination point in time belongs to the prohibited period. Therefore, the relay device reduces the number of pieces of priority data whose determination point in time belongs to the prohibited period.

### SUMMARY

A communication device according to an aspect of the present disclosure is a communication device for transmitting data to a relay device for transmitting received data, and includes a processing unit that performs processing. The processing unit gives an instruction for data transmission to the relay device, acquires a transmission delay time from the instruction for data transmission to transmission of the data, acquires a determination delay time from reception of the data by the relay device to a determination point in time at which whether or not to transmit the received data is determined, and calculates an entire period from the instruction for data transmission to the determination point in time based on the acquired transmission delay time and determination delay time.

A relay device according to an aspect of the present disclosure is a relay device for transmitting data received from a communication device, and includes: a receiving unit that receives data from the communication device; and a processing unit that performs processing. The processing unit determines whether or not to transmit the data received by the receiving unit when the receiving unit receives the data, acquires a transmission delay time from when the communication device is instructed to transmit the data to when the data is transmitted, acquires a determination delay time from when the receiving unit receives the data to a determination point in time at which whether or not to transmit the received data is determined, and calculates an entire period from when the communication device is instructed to transmit the data to the determination point in time based on the acquired transmission delay time and determination delay time.

A communication method according to an aspect of the present disclosure is a communication method for performing data communication, and causes a computer to execute: a step of acquiring a transmission delay time from when a communication device is instructed to transmit data to a relay device for transmitting received data to when the data is transmitted; a step of acquiring a determination delay time from reception of the data by the relay device to a determination point in time at which whether or not to transmit the received data is determined; and a step of calculating an entire period from the instruction for data transmission to the determination point in time based on the acquired transmission delay time and determination delay time.

In addition, not only can the present disclosure be realized as a communication device or a relay device including such a characteristic processing unit, but also the present disclosure can be realized as a communication method including such characteristic processes as steps or can be realized as a computer program causing a computer to execute such steps. In addition, the present disclosure can be realized as a semiconductor integrated circuit that realizes a part or the entirety of a communication device or a relay device, or can be realized as a communication system including a communication device or a relay device.

### BRIEF DESCRIPTION OF DRAWINGS

FIG. 1 is a block diagram showing the main configuration of a communication system according to a first embodiment.

FIG. 2 is an explanatory diagram of a relay method of a relay device.

FIG. 3 is an explanatory diagram of an operation performed within a transmission buffer.

FIG. 4 is an explanatory diagram of a determination method performed by a relay device.

FIG. 5 is a chart showing a relationship between a determination point in time and an operation.

FIG. 6 is a block diagram showing the main configuration of a relay device.

FIG. 7 is an explanatory diagram of device delay time.

FIG. 8 is a chart showing the contents of target data.

FIG. 9 is a block diagram showing the main configuration of in-vehicle equipment.

FIG. 10 is an explanatory diagram of equipment delay time.

FIG. 11 is a flowchart showing the procedure of initial setting performed by the relay device and the in-vehicle equipment.

FIG. 12 is a flowchart showing the procedure of initial setting performed by the relay device and the in-vehicle equipment.

FIG. 13 is a flowchart showing the procedure of frame transmission processing.

FIG. 14 is a flowchart showing the procedure of first relay processing of a transmission buffer.

FIG. 15 is a flowchart showing the procedure of initial setting performed by a relay device and in-vehicle equipment according to a second embodiment.

FIG. 16 is a flowchart showing the procedure of initial setting performed by the relay device and the in-vehicle equipment according to a second embodiment.

FIG. 17 is a chart showing the contents of frame data.

FIG. 18 is a block diagram showing the main configuration of a relay device according to a third embodiment.

FIG. 19 is a block diagram showing the main configuration of in-vehicle equipment.

FIG. 20 is a flowchart showing the procedure of initial setting performed by the relay device and the in-vehicle equipment.

FIG. 21 is a flowchart showing the procedure of initial setting performed by a relay device and in-vehicle equipment according to a fourth embodiment.

### DETAILED DESCRIPTION OF PREFERRED EMBODIMENTS

First, embodiments of the present disclosure will be listed and described. At least some of the embodiments described below may be arbitrarily combined.

A communication device according to an aspect of the present disclosure is a communication device for transmitting data to a relay device for transmitting received data, and includes a processing unit that performs processing. The processing unit gives an instruction for data transmission to the relay device, acquires a transmission delay time from the instruction for data transmission to transmission of the data, acquires a determination delay time from reception of the data by the relay device to a determination point in time at which whether or not to transmit the received data is determined, and calculates an entire period from the instruction for data transmission to the determination point in time based on the acquired transmission delay time and determination delay time.

In the communication device according to an aspect of the present disclosure, a permitted period during which transmission of the received data is permitted and a prohibited period during which transmission of the received data is prohibited are alternately set repeatedly.

In the communication device according to an aspect of the present disclosure, the processing unit determines a point in time for giving an instruction for data transmission based on the calculated entire period.

In the communication device according to an aspect of the present disclosure, the processing unit calculates a propagation time from data transmission to data reception, and calculates the entire period based on the acquired transmission delay time and determination delay time and the calculated propagation time.

In the communication device according to an aspect of the present disclosure, the processing unit acquires the transmission delay time and the determination delay time associated with a data amount of data to be transmitted to the relay device.

A relay device according to an aspect of the present disclosure is a relay device for transmitting data received from a communication device, and includes: a receiving unit that receives data from the communication device; and a processing unit that performs processing. The processing unit determines whether or not to transmit the data received by the receiving unit when the receiving unit receives the data, acquires a transmission delay time from when the communication device is instructed to transmit the data to when the data is transmitted, acquires a determination delay time from when the receiving unit receives the data to a determination point in time at which whether or not to transmit the received data is determined, and calculates an entire period from when the communication device is instructed to transmit the data to the determination point in time based on the acquired transmission delay time and determination delay time.

In the relay device according to an aspect of the present disclosure, a permitted period during which transmission of the data received by the receiving unit is permitted and a prohibited period during which transmission of the data received by the receiving unit is prohibited are alternately set repeatedly. When the determination point in time belongs to the permitted period, the processing unit determines that the data received by the receiving unit is to be transmitted.

In the relay device according to an aspect of the present disclosure, the processing unit calculates a determination point in time for the data received by the receiving unit based on the calculated entire period, and adjusts a start point in time or length of the permitted period based on the calculated determination point in time.

A communication method according to an aspect of the present disclosure is a communication method for performing data communication, and causes a computer to execute: a step of acquiring a transmission delay time from when a communication device is instructed to transmit data to a relay device for transmitting received data to when the data is transmitted; a step of acquiring a determination delay time from reception of the data by the relay device to a determination point in time at which whether or not to transmit the received data is determined; and a step of calculating an entire period from the instruction for data transmission to the determination point in time based on the acquired transmission delay time and determination delay time.

In the above aspect, for the communication device, the relay device, and the communication method, the transmission delay time and the determination delay time are measured in advance, for example. The processing unit of the communication device or the relay device or the computer calculates the entire period from the instruction for data transmission to the determination point in time based on the transmission delay time and the determination delay time measured in advance.

In the above aspect, for the communication device and the relay device, the permitted period and the prohibited period are alternately set repeatedly. In the relay device, when the determination point in time belongs to the permitted period, the instruction for transmission of the received data is given.

In the above aspect, the communication device determines the point in time for transmission instruction based on the calculated entire period so that the determination point in time belongs to the permitted period. The communication device gives an instruction for data transmission to the relay device at the determined point in time. Therefore, the relay device quickly transmits the received data.

In the above aspect, the communication device calculates the propagation time from data transmission to data reception by the relay device. The communication device calculates the entire period by adding up the transmission delay time, the propagation time, and the determination delay time.

In the above aspect, the communication device acquires the transmission delay time and determination delay time associated with the data amount. The communication device calculates the entire period corresponding to the data amount of the data to be transmitted. The communication device determines, for example, the point in time for giving an instruction for data transmission based on the calculated entire period.

In the above aspect, the relay device calculates the determination point in time based on the entire period. Based on the calculated determination point in time, the relay device adjusts the start point in time or length of the permitted period so that the determination point in time of the data received from the communication device belongs to the permitted period, for example.

Specific examples of communication systems according to embodiments of the present disclosure will be described below with reference to the diagrams. In addition, the present disclosure is not limited to these examples but is defined by the claims, and is intended to include all modifications within the meaning and scope equivalent to the claims.

### (First Embodiment) <Configuration of a Communication System>

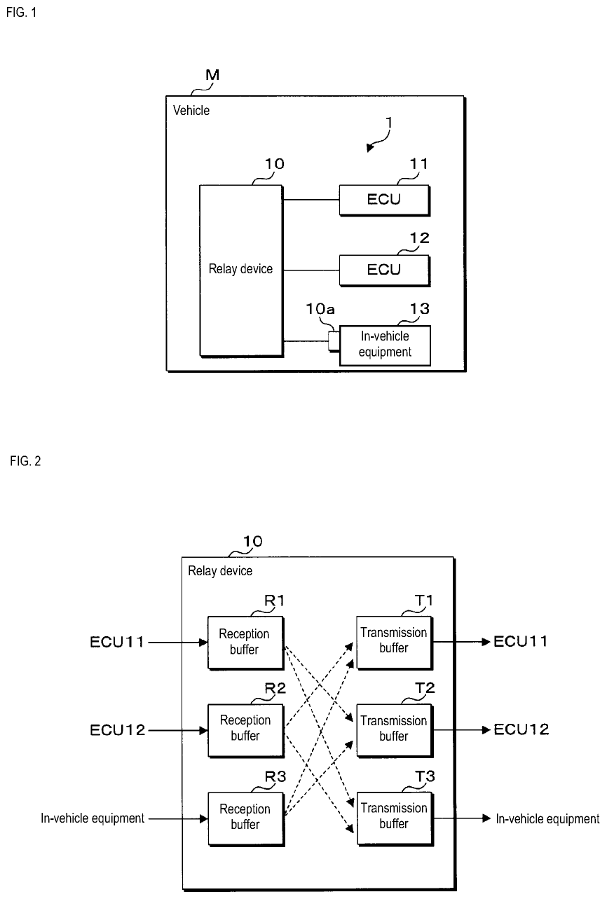

FIG. 1 is a block diagram showing the main configuration of a communication system 1 according to a first embodiment. The communication system 1 is mounted in a vehicle M. The communication system 1 includes a relay device 10, two ECUs 11 and 12, and in-vehicle equipment 13. ECU is an abbreviation for Electronic Control Unit. The two ECUs 11 and 12 are separately connected to the relay device 10. A connector 10a is further connected to the relay device 10. The in-vehicle equipment 13 is detachably connected to the connector 10a.

Each of the ECUs 11 and 12 and the in-vehicle equipment 13 functions as a communication device. Each of the ECUs 11 and 12 and the in-vehicle equipment 13 transmits and receives data frames. A data frame is data having a plurality of bits. The relay device 10 receives a data frame from each of the ECUs 11 and 12 and the in-vehicle equipment 13. The relay device 10 transmits a data frame to each of the ECUs 11 and 12 and the in-vehicle equipment 13. The relay device 10 transmits a data frame received from the ECU 11 to the ECU 12 or the in-vehicle equipment 13. The relay device 10 transmits a data frame received from the ECU 12 to the ECU 11 or the in-vehicle equipment 13. The relay device 10 transmits a data frame received from the in-vehicle equipment 13 to the ECU 11 or the ECU 12.

Each of the ECUs 11 and 12 and the in-vehicle equipment 13 transmits a data frame including sensor data, instruction data, or the like to the relay device 10. The sensor data indicates a detection value detected by a sensor. The vehicle M has, for example, a reception unit that receives an instruction from an occupant. The instruction data indicates, for example, an instruction received by the reception unit. The instruction data indicates, for example, an instruction to lock or unlock the door. Electrical equipment is connected to each of the ECUs 11 and 12. Each of the ECUs 11 and 12 controls the operation of the electrical equipment by outputting a control signal to the electrical equipment. Each of the ECUs 11 and 12 determines an operation to be performed by the electrical equipment based on the data frame received through the relay device 10, and causes the electrical equipment to perform the determined operation. When the data frame is received through the relay device 10, the in-vehicle equipment 13 performs an operation based on the received data frame.

### <Operation of the Relay Device 10>

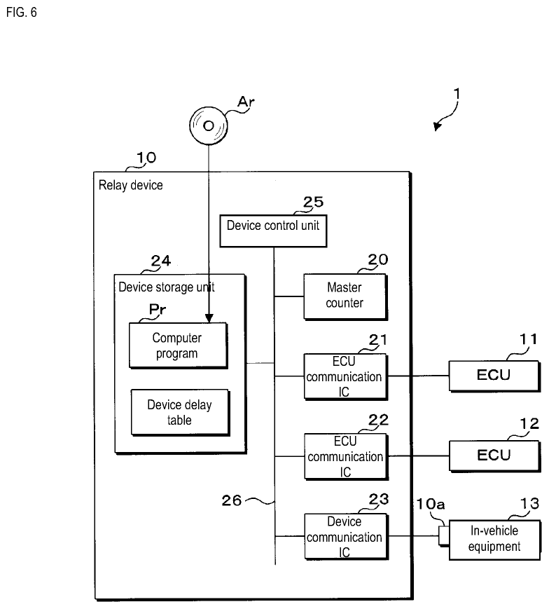

FIG. 2 is an explanatory diagram of a relay method of the relay device 10. The relay device 10 has a device storage unit 24 (see FIG. 6). In the device storage unit 24, as shown in FIG. 2, three reception buffers R1, R2, and R3 and three transmission buffers T1, T2, and T3 are provided as storage areas. The relay device 10 writes the data frames received from each of the ECUs 11 and 12 and the in-vehicle equipment 13 into the reception buffers R1, R2, and R3.

Data frames whose transmission destinations are the ECUs 11 and 12 and the in-vehicle equipment 13 are written in the transmission buffers T1, T2, and T3, respectively. The data frame indicates a transmission destination. The relay device 10 moves data frames whose transmission destination is the ECU 11, among the data frames stored in the reception buffers R2 and R3, to the transmission buffer T1. Among the data frames stored in the reception buffers R1 and R3, data frames whose transmission destination is the ECU 12 are moved to the transmission buffer T2. Among the data frames stored in the reception buffers R1 and R2, data frames whose transmission destination is the in-vehicle equipment 13 are moved to the transmission buffer T3.

The relay device 10 transmits the data frames stored in the transmission buffers T1, T2, and T3 to the ECUs 11 and 12 and the in-vehicle equipment 13, respectively.

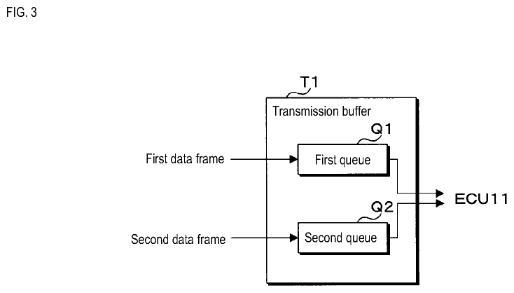

FIG. 3 is an explanatory diagram of an operation performed in the transmission buffer T1. In each of the transmission buffers T1, T2, and T3, a first queue Q1 and a second queue Q2 are provided as storage areas. Each of the ECUs 11 and 12 and the in-vehicle equipment 13 transmits two types of data frames. Hereinafter, the two types of data frames will be referred to as a first data frame and a second data frame.

The relay device 10 writes the first data frame whose transmission destination is the ECU 11 to the first queue Q1 in the transmission buffer T1. In addition, the relay device 10 writes the second data frame whose transmission destination is the ECU 11 to the second queue Q2 in the transmission buffer T1. The writing performed by the relay device 10 in each of the transmission buffers T2 and T3 is the same as the writing performed by the relay device 10 in the transmission buffer T1. The relay device 10 writes the first data frame and the second data frame whose transmission destination is the ECU 12 to the first queue Q1 and the second queue Q2 of the transmission buffer T2, respectively. The relay device 10 writes the first data frame and the second data frame whose transmission destination is the in-vehicle equipment 13 to the first queue Q1 and the second queue Q2 of the transmission buffer T3, respectively.

In each of the transmission buffers T1, T2, and T3, the relay device 10 determines whether or not to transmit the first data frame stored in the first queue Q1. When the relay device 10 determines that the first data frame is to be transmitted, an instruction to transmit the first data frame is given. After the first data frame is transmitted, the relay device 10 discards the transmitted first data frame. The data frame is discarded by deleting the data frame from the device storage unit 24.

When the relay device 10 determines that the first data frame is not to be transmitted, the relay device 10 discards the first data frame without transmitting the first data frame. The first data frame is determined according to the order of writing to the first queue Q1. For the first data frame, the earlier the order of writing to the first queue Q1, the earlier the order of determination.

Similarly, in each of the transmission buffers T1, T2, and T3, the relay device 10 determines whether or not to transmit the second data frame stored in the second queue Q2. When the relay device 10 determines that the second data frame is to be transmitted, an instruction to transmit the second data frame is given. After the second data frame is transmitted, the relay device 10 discards the transmitted second data frame. When the relay device 10 determines that the second data frame is not to be transmitted, the relay device 10 discards the second data frame without transmitting the second data frame. The second data frame is determined according to the order of writing to the second queue Q2.

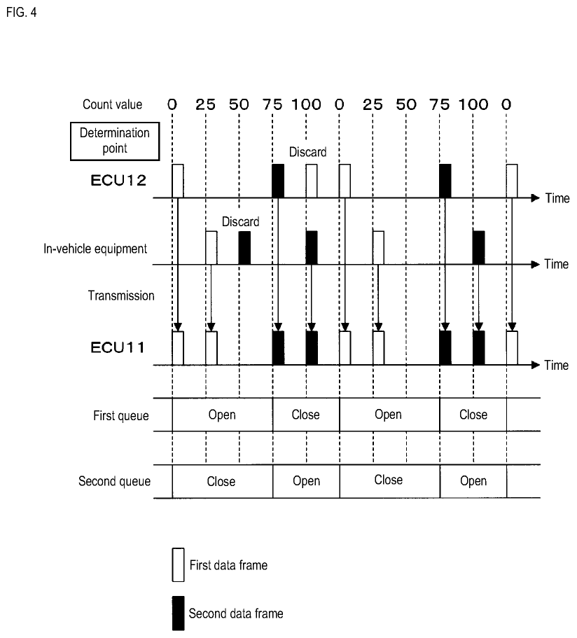

FIG. 4 is an explanatory diagram of a determination method performed by the relay device 10. FIG. 4 shows a method of determining the first data frame and the second data frame stored in the transmission buffer T1. The relay device 10 has a master counter 20 (see FIG. 6). A count value is stored in the master counter 20. The count value of the master counter 20 is shown in FIG. 4.

A certain count number is determined in advance. The count number is 2 or more. The master counter 20 increments the count value by 1 each time a predetermined period passes. When the count value (count number) is −1, the master counter 20 resets the count value to zero after the predetermined period passes. In the example of FIG. 4, the count number is 125. One cycle is expressed by (count number)·(predetermined period). “·” represents a product.

As shown in FIG. 4, for each of the first queue Q1 and the second queue Q2, an open period and a close period are set in association with the count value. In the example of FIG. 4, for the first queue Q1, a period during which the count value is a value within the range of 0 to 74 is the open period. For the first queue Q1, a period during which the count value is a value within the range of 75 to 124 is the close period. For the second queue Q2, a period during which the count value is a value within the range of 0 to 74 is the close period. For the second queue Q2, a period during which the count value is a value within the range of 75 to 124 is the open period.

In FIG. 4, the first data frame is expressed by a white rectangle. The second data frame is expressed by a black rectangle. A determination point in time at which the relay device 10 determines whether or not to transmit each of the first data frame and the second data frame received from the ECU 12 is shown. Similarly, a determination point in time for each of the first data frame and the second data frame received from the in-vehicle equipment 13 is shown. The first data frame and the second data frame to be transmitted to the ECU 11 are shown.

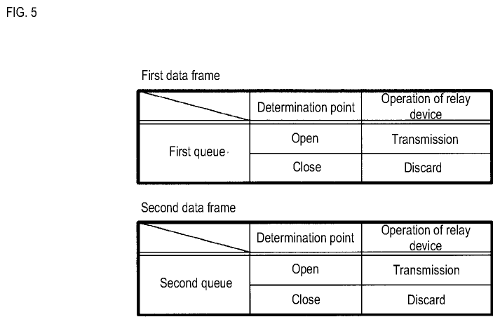

FIG. 5 is a chart showing a relationship between a determination point in time and an operation. As shown in FIGS. 4 and 5, transmission to the ECU 11 is permitted for the first data frame whose determination point in time belongs to the open period of the first queue Q1. This first data frame is quickly transmitted to the ECU 11 by the relay device 10. The transmitted first data frame is discarded. The first data frame whose determination point in time belongs to the close period of the first queue Q1 is discarded.

Similarly, transmission to the ECU 11 is permitted for the second data frame whose determination point in time belongs to the open period of the second queue Q2. This second data frame is quickly transmitted to the ECU 11 by the relay device 10. The transmitted second data frame is discarded. The second data frame whose determination point in time belongs to the close period of the second queue Q2 is discarded.

The method of determining the first data frame and the second data frame stored in each of the transmission buffers T2 and T3 is the same as the method of determining the first data frame and the second data frame stored in the transmission buffer T1. In the method of determining the first data frame and the second data frame stored in the transmission buffer T2, the transmission sources are the ECU 11 and the in-vehicle equipment 13. The transmission destination is the ECU 12. In the method of determining the first data frame and the second data frame stored in the transmission buffer T3, the transmission sources are the ECUs 11 and 12. The transmission destination is the in-vehicle equipment 13.

The relay device 10 transmits and discards data frames according to the IEEE802.1Qbv and IEEE802.1Qci standards, as described above. IEEE is a registered trademark, and is an abbreviation for Institute of Electrical and Electronics Engineers. The open period is a period during which transmission of the data frame received by the relay device 10 is permitted, and corresponds to the permitted period. The close period is a period during which transmission of the data frame received by the relay device 10 is prohibited, and corresponds to the prohibited period. As described above, when the count value (count number) is −1, the master counter 20 resets the count value to zero after the predetermined period passes. Therefore, the open period and the prohibited period are alternately set repeatedly.

### <Configuration of the Relay Device 10>

FIG. 6 is a block diagram showing the main configuration of the relay device 10. The relay device 10 has the master counter 20 and the device storage unit 24 as described above. The relay device 10 further has two ECU communication ICs 21 and 22, a device communication IC 23, and a device control unit 25. IC is an abbreviation for Integrated Circuit. The master counter 20, the ECU communication ICs 21 and 22, the device communication IC 23, the device storage unit 24, and the device control unit 25 are connected to a device bus 26. The ECU communication ICs 21 and 22 are further connected to the ECUs 11 and 12, respectively. The device communication IC 23 is connected to the connector 10a. As described above, the in-vehicle equipment 13 is connected to the connector 10a.

The ECU communication ICs 21 and 22 and the device communication IC 23 receive data frames, request data, and the like from the ECUs 11 and 12 and the in-vehicle equipment 13, respectively. The device communication IC 23 functions as a receiving unit. Data frames received by the relay device 10 are data frames received by the ECU communication ICs 21 and 22 and the device communication IC 23. The ECU communication ICs 21 and 22 and the device communication IC 23 transmit data frames, response data, count data, device delay data, target data, and the like to the ECUs 11 and 12 and the in-vehicle equipment 13, respectively, according to instructions from the device control unit 25.

The request data is data for making a request for transmission of response data. The response data is data transmitted when request data is received. The count data indicates the count value of the master counter 20. The device delay data indicates a device delay time. The target data indicates a target point in time.

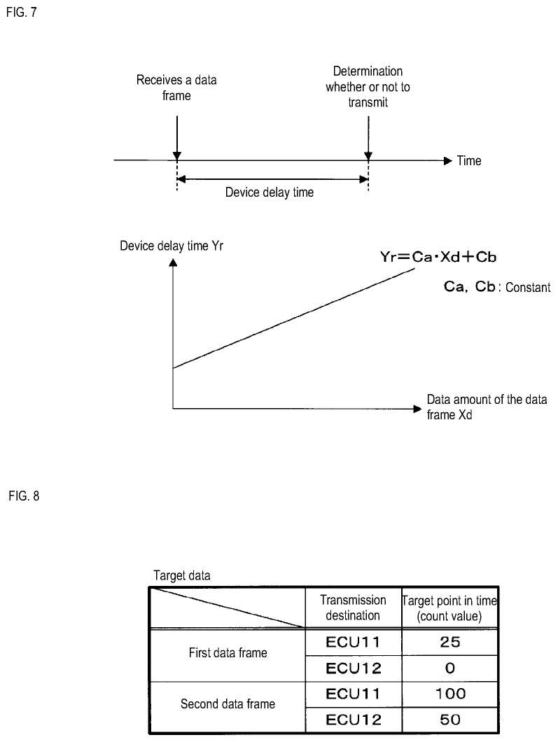

FIG. 7 is an explanatory diagram of the device delay time. The device delay time is a period from when one of the ECU communication ICs 21 and 22 and the device communication IC 23 receives a data frame to the determination point in time at which whether or not to transmit the received data is determined. The device delay time corresponds to the determination delay time. The device delay time is associated with the data amount of the data frame transmitted to the relay device 10. The device delay time increases as the data amount of the data frame received by the relay device 10 increases. The device delay time and the data amount of the data frame are denoted as Yr and Xd, respectively. The device delay time Yr is approximated, for example, by the following Equation (1).

$$Yr = Ca \cdot Xd + Cb \qquad ( 1 )$$

Each of Ca and Cb is a constant. The constant Ca is greater than zero. The device delay data indicates the device delay time Yr corresponding to the data amount Xd. Specifically, the device delay data indicates Equation (1). The device delay time Yr is measured in advance.

FIG. 8 is a chart showing the contents of target data. The target data indicates target points in time of the first data frame and the second data frame. The target point in time is the count value of the master counter 20 for determining whether or not to transmit the data frame. FIG. 8 shows target data used by the in-vehicle equipment 13. In this case, the in-vehicle equipment 13 transmits the first data frame and the second data frame to the device communication IC 23 so that the determination point in time for determining whether or not to transmit the data frame is the target point in time.

In the example of FIG. 8, the in-vehicle equipment 13 transmits the first data frame whose transmission destination is the ECU 11 so that whether or not to transmit the first data frame is determined when the count value of the master counter 20 is 25. The in-vehicle equipment 13 transmits the first data frame whose transmission destination is the ECU 12 so that whether or not to transmit the first data frame is determined when the count value of the master counter 20 is zero.

The in-vehicle equipment 13 transmits the second data frame whose transmission destination is the ECU 11 so that whether or not to transmit the second data frame is determined when the count value of the master counter 20 is 100. The in-vehicle equipment 13 transmits the second data frame whose transmission destination is the ECU 12 so that whether or not to transmit the second data frame is determined when the count value of the master counter 20 is 50.

The contents of the target data used by each of the ECUs 11 and 12 are the same as the contents of the target data used by the in-vehicle equipment 13. In the target data used by the ECU 11, the contents of a data frame whose transmission destination is the ECU 12 or the in-vehicle equipment 13 are shown. In the target data used by the ECU 12, the contents of a data frame whose transmission destination is the ECU 11 or the in-vehicle equipment 13 are shown. It is preferable that the target points in time of a plurality of first data frames having the same transmission destination and different transmission sources are different. Similarly, it is preferable that the target points in time of a plurality of second data frames having the same transmission destination and different transmission sources are different.

Equipment delay data is stored in the device storage unit 24 shown in FIG. 6. The device control unit 25 has a processing element that performs processing, for example, a CPU (Central Processing Unit). The device control unit 25 functions as a processing unit. A computer program Pr is further stored in the device storage unit 24. The computer program Pr is a program product. By executing the computer program Pr, the processing element (computer) of the device control unit 25 performs data transmission processing, data movement processing, first relay processing and second relay processing of the transmission buffer T1, first relay processing and second relay processing of the transmission buffer T2, first relay processing and second relay processing of the transmission buffer T3, and the like.

The data transmission processing is processing for transmitting count data, request data, device delay data, target data, and the like. The data movement processing is processing for moving a data frame from one of the reception buffers R1, R2, and R3 to at least one of the transmission buffers T1, T2, and T3. The first relay processing is processing for relaying the first data frame. The second relay processing is processing for relaying the second data frame.

In addition, the computer program Pr may be provided to the relay device 10 by using a non-transitory storage medium Ar in which the computer program Pr is stored in a readable manner. The storage medium Ar is, for example, a portable memory. Examples of the portable memory include a CD-ROM, a USB (Universal Serial Bus) memory, an SD card, a micro SD card, and a compact flash (registered trademark). If the storage medium Ar is a portable memory, the processing element of the device control unit 25 may read the computer program Pr from the storage medium Ar by using a reader (not shown). The read computer program Pr is written in the device storage unit 24. In addition, the computer program Pr may be provided to the relay device 10 by a communication unit (not shown) of the relay device 10 communicating with an external device. In this case, the processing element of the device control unit 25 acquires the computer program Pr through the communication unit. The acquired computer program Pr is written in the device storage unit 24.

In addition, the number of processing elements included in the device control unit 25 is not limited to one, and may be two or more. When the device control unit 25 has a plurality of processing elements, the plurality of processing elements may cooperate with each other to perform the data transmission processing, the first relay processing and the second relay processing of the transmission buffer T1, the first relay processing and the second relay processing of the transmission buffer T2, the first relay processing and the second relay processing of the transmission buffer T3, and the like.

The device storage unit 24 is formed by, for example, a non-volatile memory and a volatile memory. In this case, the non-volatile memory of the device storage unit 24 stores, for example, the computer program Pr, device delay data, target data, and the like. For example, the three reception buffers R1, R2, and R3 and the three transmission buffers T1, T2, and T3 are provided in the storage area of the volatile memory of the device storage unit 24.

### <Configuration of the In-Vehicle Equipment 13>

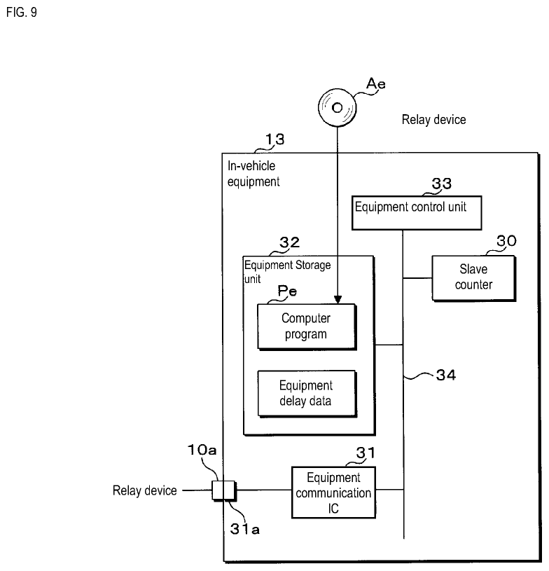

FIG. 9 is a block diagram showing the main configuration of the in-vehicle equipment 13. The in-vehicle equipment 13 has a slave counter 30, an equipment communication IC 31, an equipment storage unit 32, and an equipment control unit 33. These are connected to an equipment bus 34. The equipment communication IC 31 is further connected to an equipment connector 31a. The equipment connector 31a is detachably connected to the connector 10a.

A count value is stored in the slave counter 30. Similar to the master counter 20, the slave counter 30 increments the count value by one each time a predetermined period passes. The predetermined period and the count number of the slave counter 30 are the same as the predetermined period and the count number of the master counter 20. When the count value (count number) is −1, the slave counter 30 resets the count value to zero after the predetermined period passes. The equipment control unit 33 synchronizes the count value of the slave counter 30 with the count value of the master counter 20.

The equipment communication IC 31 receives data frames, response data, count data, device delay data, target data, and the like from the device communication IC 23 of the relay device 10. The equipment communication IC 31 transmits data frames, request data, and the like according to instructions from the equipment control unit 33.

The equipment storage unit 32 stores equipment delay data. The equipment delay data indicates an equipment delay time. Target data for the in-vehicle equipment 13 is written in the equipment storage unit 32.

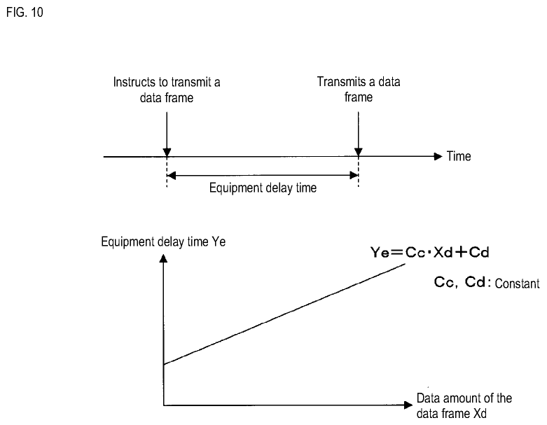

FIG. 10 is an explanatory diagram of the equipment delay time. The equipment delay time is a period from when the equipment control unit 33 in the in-vehicle equipment 13 instructs the equipment communication IC 31 to transmit a data frame to the relay device 10 to when the equipment communication IC 31 transmits the data frame. The equipment delay time corresponds to the transmission delay time. The equipment delay time is associated with the data amount of the data frame transmitted to the relay device 10. The equipment delay time increases as the data amount of the data frame to be transmitted increases. The equipment delay time is described as Ye. The equipment delay time Ye is approximated, for example, by the following Equation (2).

$$Ye = Cc \cdot Xd + Cd \qquad ( 2 )$$

Xd is the data amount of the data frame as described above. Each of Cc and Cd is a constant. The constant Cc is greater than zero. The equipment delay data indicates the equipment delay time Ye corresponding to the data amount Xd. Specifically, the equipment delay data indicates Equation (2). The equipment delay time Ye is measured in advance.

The equipment control unit 33 shown in FIG. 9 has a processing element that performs processing, for example, a CPU. The equipment control unit 33 functions as a processing unit. A computer program Pe is stored in the equipment storage unit 32. The computer program Pe is a program product. The processing element (computer) of the equipment control unit 33 performs adjustment processing, writing processing, frame transmission processing, and the like by executing the computer program Pe.

In the adjustment processing, the equipment control unit 33 adjusts the count value of the slave counter 30. In the adjustment processing, the equipment control unit 33 further writes propagation time data, device delay data, target data, and the like into the equipment storage unit 32. The writing processing is processing for writing the data frame to be transmitted to one of the ECUs 11 and 12 into the equipment storage unit 32. The frame transmission processing is processing for transmitting the data frame to the relay device 10. The propagation time data indicates a propagation time. The propagation time is a period from when the equipment communication IC 31 transmits the data frame to when the device communication IC 23 of the relay device 10 receives the data frame.

In addition, the computer program Pe may be provided to the in-vehicle equipment 13 by using a non-transitory storage medium Ae in which the computer program Pe is stored in a readable manner. The storage medium Ae is, for example, a portable memory. If the storage medium Ae is a portable memory, the processing element of the equipment control unit 33 may read the computer program Pe from the storage medium Ar by using a reader (not shown). The read computer program Pe is written in the equipment storage unit 32. In addition, the computer program Pe may be provided to the in-vehicle equipment 13 by a communication unit (not shown) of the in-vehicle equipment 13 communicating with an external device. In this case, the processing element of the equipment control unit 33 acquires the computer program Pe through the communication unit. The acquired computer program Pe is written in the equipment storage unit 32.

In addition, the number of processing elements included in the equipment control unit 33 is not limited to one, and may be two or more. When the equipment control unit 33 has a plurality of processing elements, the plurality of processing elements may cooperate with each other to perform adjustment processing, frame transmission processing, and the like.

The equipment storage unit 32 is formed by, for example, a non-volatile memory and a volatile memory. In this case, the non-volatile memory of the equipment storage unit 32 stores, for example, the computer program Pe, equipment delay data, propagation time data, device delay data, target data, and the like.

### <Initial Setting>

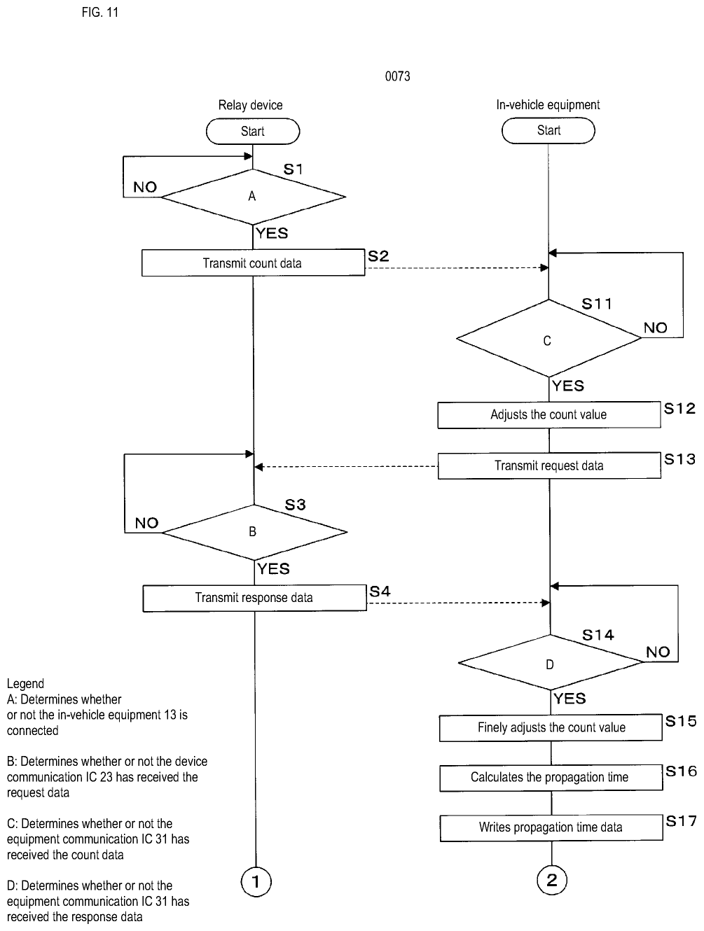

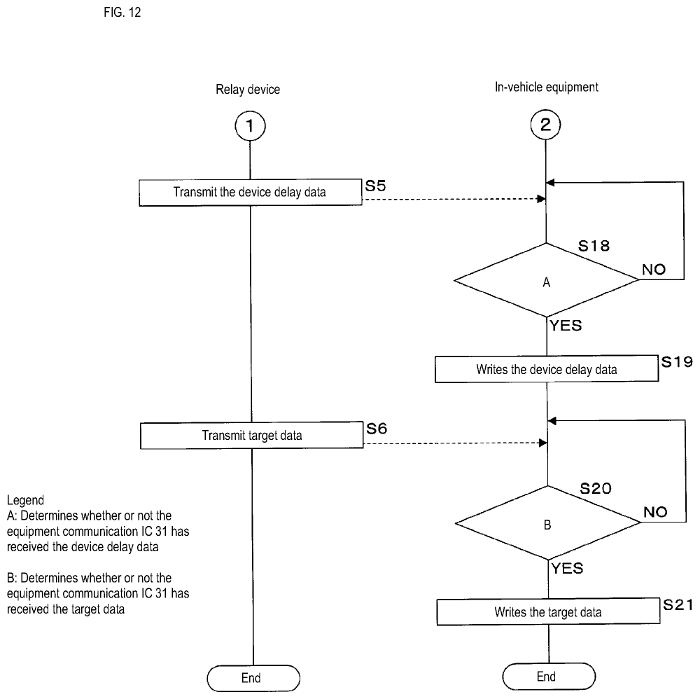

FIGS. 11 and 12 are flowcharts showing the procedure of initial setting performed by the relay device 10 and the in-vehicle equipment 13. In the initial setting, the device control unit 25 of the relay device 10 performs data transmission processing. The equipment control unit 33 of the in-vehicle equipment 13 performs adjustment processing. The device control unit 25 of the relay device 10 performs data transmission processing when the in-vehicle equipment 13 is disconnected from the connector 10a. The equipment control unit 33 of the in-vehicle equipment 13 performs adjustment processing when the in-vehicle equipment 13 is connected to the connector 10a.

In the data transmission processing, the device control unit 25 determines whether or not the in-vehicle equipment 13 is connected to the connector 10a (step S1). When it is determined that the in-vehicle equipment 13 is not connected to the connector 10a (S1: NO), the device control unit 25 executes step S1 again and waits until the in-vehicle equipment 13 is connected to the connector 10a. When it is determined that the in-vehicle equipment 13 is connected to the connector 10a (S1: YES), the device control unit 25 instructs the device communication IC 23 to transmit count data indicating the count value of the master counter 20 to the equipment communication IC 31 of the in-vehicle equipment 13 (step S2).

In the adjustment processing, the equipment control unit 33 of the in-vehicle equipment 13 determines whether or not the equipment communication IC 31 has received the count data (step S11). When it is determined that the equipment communication IC 31 has not received the count data (S11: NO), the equipment control unit 33 executes step S11 again and waits until the equipment communication IC 31 receives the count data. When it is determined that the equipment communication IC 31 has received the count data (S11: YES), the equipment control unit 33 adjusts the count value of the slave counter 30 to the count value indicated by the count data received by the equipment communication IC 31 (step S12).

Then, the equipment control unit 33 instructs the equipment communication IC 31 to transmit request data to the device communication IC 23 of the relay device 10 (step S13). The request data includes equipment transmission count information indicating the count value of the slave counter 30 at the point in time when the request data is transmitted. Hereinafter, the count value of the slave counter 30 at the point in time when the request data is transmitted will be referred to as an equipment transmission count value.

After executing step S2, the device control unit 25 of the relay device 10 determines whether or not the device communication IC 23 has received the request data (step S3). When it is determined that the device communication IC 23 has not received the request data (S3: NO), the device control unit 25 executes step S3 again and waits until the device communication IC 23 receives the request data. When it is determined that the device communication IC 23 has received the request data (S3: YES), the device control unit 25 instructs the device communication IC 23 to transmit response data to the equipment communication IC 31 of the in-vehicle equipment 13 (step S4).

The response data includes the equipment transmission count information included in the request data, device reception count information, and device transmission count information. The device reception count information indicates the count value of the master counter 20 at the point in time when the device communication IC 23 receives the request data. The device transmission count information indicates the count value of the master counter 20 at the point in time when the device communication IC 23 transmits the response data. Hereinafter, the count value of the master counter 20 at the point in time when the device communication IC 23 receives the request data will be referred to as a device reception count value. The count value of the master counter 20 at the point in time when the device communication IC 23 transmits the response data will be referred to as a device transmission count value.

After executing step S13, the equipment control unit 33 of the in-vehicle equipment 13 determines whether or not the equipment communication IC 31 has received the response data from the device communication IC 23 of the relay device 10 (step S14). When it is determined that the equipment communication IC 31 has not received the response data (S14: NO), the equipment control unit 33 executes step S14 again and waits until the equipment communication IC 31 receives the response data.

Hereinafter, the count value of the slave counter 30 at the point in time when the equipment communication IC 31 receives the response data will be referred to as a device reception count value. As described above, the response data includes equipment transmission count information, device reception count information, and device transmission count information.

The equipment transmission count value, the device reception count value, the device transmission count value, and the equipment reception count value are represented by Het, Hrr, Hrt, and Her, respectively. It is assumed that the propagation times of request data and response data are the same. In this case, a difference Hd between the count values of the master counter 20 and the slave counter 30 is expressed by the following Equation (3).

$$Hd = ( ( Hrr - Het ) - ( Her - Hrt ) ) / 2 \qquad ( 3 )$$

When it is determined that the equipment communication IC 31 has received the response data (S14: YES), the equipment control unit 33 finely adjusts the count value of the slave counter 30 based on the difference Hd (step S15). As described above, when the equipment communication IC 31 of the in-vehicle equipment 13 receives the count data from the device communication IC 23 of the relay device 10, the equipment control unit 33 adjusts the count value of the slave counter 30 to the count value indicated by the count data received by the equipment communication IC 31. Therefore, the count value of the slave counter 30 is smaller than the actual count value of the master counter 20.

In step S15, the equipment control unit 33 increases the count value of the slave counter 30 by the absolute value of the difference Hd. As a result, the count value of the slave counter 30 is substantially the same as the count value of the master counter 20.

In addition, the method of calculating the difference Hd is not limited to the method using Equation (3).

Then, the equipment control unit 33 calculates the propagation time of the data frame based on the equipment transmission count value Het, the device reception count value Hrr, the device transmission count value Hrt, and the equipment reception count value Her (step S16). It is assumed that the propagation time of the data frame is the same as the propagation time of the request data (response data). The propagation time of the data frame is referred to as Ht. The propagation time Ht is expressed by the following Equation (4).

$$Ht = ( ( Hrr - Het ) + ( Her - Hrt ) ) / 2 \qquad ( 4 )$$

In addition, the method of calculating the propagation time Ht is not limited to the method using Equation (4).

In Equations (3) and (4), when Hrr is smaller than Het, a numerical value required for the count value to reach Hrr from Het is used as (Hrr−Het). When Hrt is smaller than Her, a numerical value required for the count value to reach Her from Hrt is used as (Her−Hrt).

Then, the equipment control unit 33 writes propagation time data indicating the propagation time calculated in step S16 into the equipment storage unit 32 (step S17). After executing step S4, the device control unit 25 of the relay device 10 instructs the device communication IC 23 to transmit the device delay data stored in the device storage unit 24 to the equipment communication IC 31 of the in-vehicle equipment 13 (step S5).

After executing step S17, the equipment control unit 33 of the in-vehicle equipment 13 determines whether or not the equipment communication IC 31 has received the device delay data from the device communication IC 23 (step S18). When it is determined that the equipment communication IC 31 has not received the device delay data (S18: NO), the equipment control unit 33 executes step S18 again and waits until the equipment communication IC 31 receives the device delay data.

When it is determined that the equipment communication IC 31 has received the device delay data (S18: YES), the equipment control unit 33 writes the device delay data received by the equipment communication IC 31 into the equipment storage unit 32 (step S19). After executing step S5, the device control unit 25 of the relay device 10 instructs the device communication IC 23 to transmit target data for the in-vehicle equipment 13 to the equipment communication IC 31 of the in-vehicle equipment 13 (step S6). As described above, the target data for the in-vehicle equipment 13 is stored in the device storage unit 24. After executing step S6, the device control unit 25 ends the data transmission processing. When the in-vehicle equipment 13 is disconnected from the connector 10a, the device control unit 25 performs the data transmission processing again.

After executing step S19, the equipment control unit 33 of the in-vehicle equipment 13 determines whether or not the equipment communication IC 31 has received the target data for the in-vehicle equipment 13 from the device communication IC 23 (step S20). When it is determined that the equipment communication IC 31 has not received the target data for the in-vehicle equipment 13 (S20: NO), the equipment control unit 33 executes step S20 again and waits until the equipment communication IC 31 receives the target data for the in-vehicle equipment 13.

When it is determined that the equipment communication IC 31 has received the target data for the in-vehicle equipment 13 (S20: YES), the equipment control unit 33 writes the target data for the in-vehicle equipment 13 received by the equipment communication IC 31 into the equipment storage unit 32 (step S21). After executing step S21, the equipment control unit 33 ends the adjustment processing. After the in-vehicle equipment 13 is disconnected from the connector 10a, when the in-vehicle equipment 13 is reconnected to the connector 10a, the equipment control unit 33 performs the adjustment processing again.

As described above, when the data transmission processing and the adjustment processing have been performed by the device control unit 25 and the equipment control unit 33, respectively, the count values of the master counter 20 and the slave counter 30 are substantially the same. In addition, device delay data, propagation time data, and equipment delay data are stored in the equipment storage unit 32 of the in-vehicle equipment 13.

In addition, when the count number and the predetermined period of the slave counter 30 are not the same as the count number and the predetermined period of the master counter 20, the device communication IC 23 of the relay device 10 transmits count data indicating the count value, the count number, and the predetermined period of the master counter 20 to the equipment communication IC 31 of the in-vehicle equipment 13 in step S2. When the equipment communication IC 31 receives the count data, the equipment control unit 33 adjusts the count value, the count number, and the predetermined period of the slave counter 30 to the count value, the count number, and the predetermined period indicated by the count data.

### <Data Frame Writing Performed by the In-Vehicle Equipment 13>

As described above, the equipment control unit 33 of the in-vehicle equipment 13 performs writing processing. In a case where the in-vehicle equipment 13 has a sensor, when sensor data is input from the sensor, the equipment control unit 33 generates a data frame including the input sensor data in the writing processing. In a case where the in-vehicle equipment 13 has a reception unit that receives an instruction, when the reception unit receives an instruction, the equipment control unit 33 generates a data frame including instruction data indicating the received instruction in the writing processing. The equipment control unit 33 writes the generated data frame into the equipment storage unit 32. The data frame generated by the equipment control unit 33 is the first data frame or the second data frame.

### <Data Frame Transmission Performed by the In-Vehicle Equipment 13>

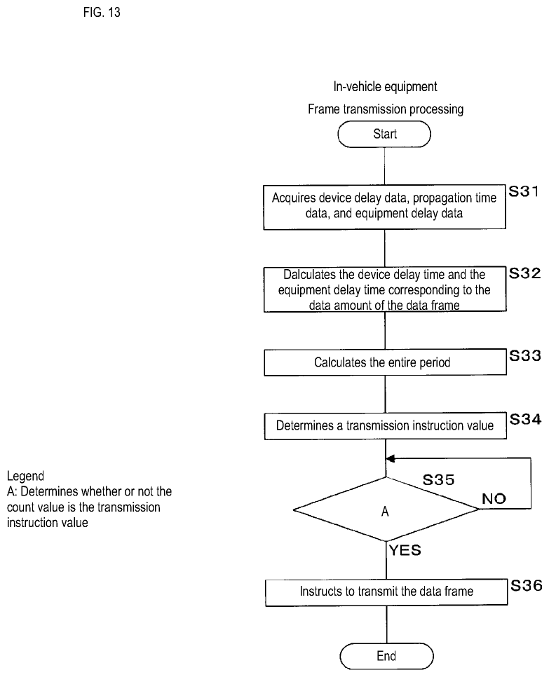

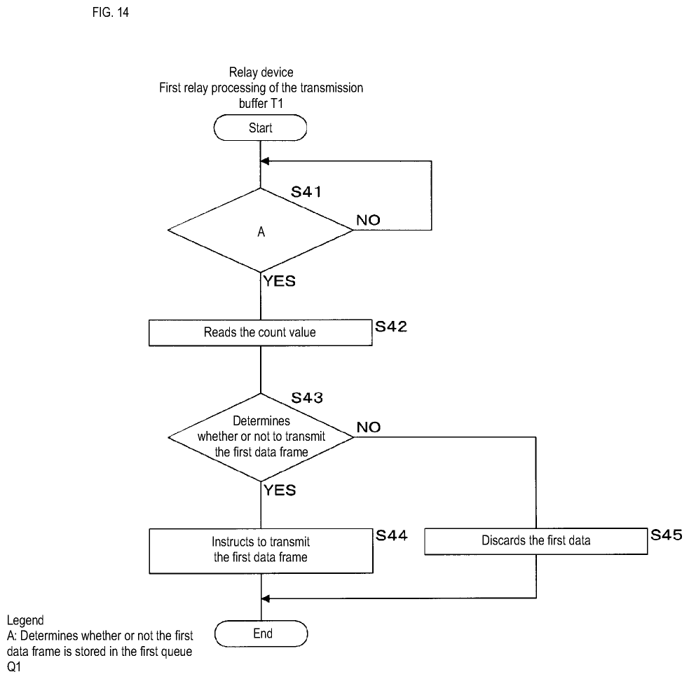

FIG. 13 is a flowchart showing the procedure of frame transmission processing. As described above, device delay data, propagation time data, and equipment delay data are stored in the equipment storage unit 32. When the data frame is written in the equipment storage unit 32, the equipment control unit 33 of the in-vehicle equipment 13 performs frame transmission processing. In the frame transmission processing, the equipment control unit 33 acquires device delay data, propagation time data, and equipment delay data from the equipment storage unit 32 (step S31). The acquisition of the device delay data corresponds to the acquisition of the device delay time associated with the data amount of the data frame. The acquisition of the equipment delay data corresponds to the acquisition of the equipment delay time associated with the data amount of the data frame.

Then, based on the device delay data and the equipment delay data acquired in step S31, the equipment control unit 33 calculates the device delay time and the equipment delay time corresponding to the data amount of the data frame stored in the equipment storage unit 32 (step S32).

Then, based on the device delay time and the equipment delay time calculated in step S32 and the propagation time indicated by the propagation time data, the equipment control unit 33 calculates the entire period corresponding to the data amount of the data frame stored in the equipment storage unit 32 (step S33). The entire period is a period from when the equipment control unit 33 of the in-vehicle equipment 13 gives an instruction to transmit the data frame to the determination point in time. The entire period is calculated by adding up the device delay time, the propagation time, and the equipment delay time.

Then, the equipment control unit 33 determines a transmission instruction value based on the target point in time indicated by the target data and the entire period calculated in step S33 (step S34). The transmission instruction value is the count value (point in time) of the slave counter 30 at which the equipment control unit 33 gives an instruction to transmit the data frame.

It is assumed that the data frame stored in the equipment storage unit 32 is the second data frame whose transmission destination is the ECU 11. In this case, as shown in FIG. 8, the target point in time of the second data frame is 100. It is assumed that the width of the count value obtained by dividing the entire period by the predetermined period is 30. In this case, the transmission instruction value is 70 (=100−30). It is assumed that the data frame stored in the equipment storage unit 32 is the first data frame whose transmission destination is the ECU 11. In this case, the target point in time of the first data frame is 25. When the count number is 125, the transmission instruction value is 120 (=25−30+125).

After executing step S34, the equipment control unit 33 determines whether or not the count value of the slave counter 30 is the transmission instruction value determined in step S34 (step S35). When it is determined that the count value is not the transmission instruction value (S35: NO), the equipment control unit 33 executes step S35 again and waits until the count value becomes the transmission instruction value.

When it is determined that the count value is the transmission instruction value (S35: YES), the equipment control unit 33 instructs the equipment communication IC 31 to transmit the data frame stored in the equipment storage unit 32 to the relay device 10 (step S36). After executing step S36, the equipment control unit 33 ends the frame transmission processing.

### <Data Frame Transmission Performed by the ECUs 11 and 12>

Each of the ECUs 11 and 12 is configured similarly to the in-vehicle equipment 13. When each of the ECUs 11 and 12 is connected to the relay device 10, each of the ECUs 11 and 12 matches the count value of the slave counter 30 with the count value of the master counter 20 in the same manner as the in-vehicle equipment 13. Each of the ECUs 11 and 12 calculates the propagation time in the same manner as the in-vehicle equipment 13. The relay device 10 transmits device delay data to each of the ECUs 11 and 12. The relay device 10 transmits target data for the ECU 11 and target data for the ECU 12 to the ECUs 11 and 12, respectively. Each of the ECUs 11 and 12 performs frame transmission processing in the same manner as the in-vehicle equipment 13.

### <Data Frame Movement Performed by the Relay Device 10>

As described above, the device control unit 25 of the relay device 10 performs data movement processing. In the data movement processing, the device control unit 25 writes data frames received by the ECU communication ICs 21 and 22 and the device communication IC 23 into the reception buffers R1, R2, and R3, respectively. The device control unit 25 moves data frames whose transmission destination is the ECU 11, among the data frames stored in the reception buffers R2 and R3, to the transmission buffer T1. Here, the device control unit 25 moves the first data frame to the first queue Q1 of the transmission buffer T1. The device control unit 25 moves the second data frame to the second queue Q2 of the transmission buffer T1.

Similarly, the device control unit 25 moves data frames whose transmission destination is the ECU 12, among the data frames stored in the reception buffers R1 and R3, to the transmission buffer T2. Here, the device control unit 25 moves the first data frame to the first queue Q1 of the transmission buffer T2. The device control unit 25 moves the second data frame to the second queue Q2 of the transmission buffer T2. The device control unit 25 moves data frames whose transmission destination is the in-vehicle equipment 13, among the data frames stored in the reception buffers R1 and R2, to the transmission buffer T3. Here, the device control unit 25 moves the first data frame to the first queue Q1 of the transmission buffer T3. The device control unit 25 moves the second data frame to the second queue Q2 of the transmission buffer T3.

### <Data Frame Relay Performed by the Relay Device 10>

FIG. 14 is a flowchart showing the procedure of first relay processing of the transmission buffer T1. In the first relay processing of the transmission buffer T1, the device control unit 25 of the relay device 10 determines whether or not the first data frame is stored in the first queue Q1 of the transmission buffer T1 (step S41). When it is determined that the first data frame is not stored in the first queue Q1 (S41: NO), the device control unit 25 executes step S41 again and waits until the first data frame is stored in the first queue Q1.

When it is determined that the first data frame is stored in the first queue Q1 (S41: YES), the device control unit 25 reads the count value of the master counter 20 (step S42). Then, based on the count value read in step S42, the device control unit 25 determines whether or not to transmit the first data frame stored in the first queue Q1 to the ECU 11 (step S43).

The count value read in step S42 corresponds to a point in time for determining whether or not to transmit the first data frame. In step S43, the device control unit 25 determines that the first data frame stored in the first queue Q1 is to be transmitted when the count value read in step S42 belongs to the open period of the first queue Q1. When the count value read in step S42 belongs to the close period of the first queue Q1, the device control unit 25 determines that the first data frame is not to be transmitted.

When it is determined that the first data frame is to be transmitted (S43: YES), the device control unit 25 instructs the ECU communication IC 21 to transmit the first data frame stored in the first queue Q1 (step S44). As a result, the first data frame is transmitted to the ECU 11. When it is determined that the first data frame is not to be transmitted (S43: NO), the device control unit 25 discards the first data frame (step S45). After executing one of steps S44 and S45, the device control unit 25 ends the first relay processing of the transmission buffer T1. Thereafter, the device control unit 25 performs the first relay processing of the transmission buffer T1.

The device control unit 25 performs the second relay processing of the transmission buffer T1 in the same manner as the first relay processing of the transmission buffer T1. The second relay processing of the transmission buffer T1 can be explained by replacing the first data frame and the first queue Q1 with the second data frame and the second queue Q2, respectively, in the explanation of the first relay processing of the transmission buffer T1.

The first relay processing and the second relay processing of the transmission buffer T2 are the same as the first relay processing and the second relay processing of the transmission buffer T1, respectively. In the explanation of the first relay processing and the second relay processing of the transmission buffer T1, the transmission buffer T1 and the ECU 11 are replaced with the transmission buffer T2 and the ECU 12, respectively. In this manner, the first relay processing and the second relay processing of the transmission buffer T2 can be explained.

The first relay processing and the second relay processing of the transmission buffer T3 are also the same as the first relay processing and the second relay processing of the transmission buffer T1, respectively. In the explanation of the first relay processing and the second relay processing of the transmission buffer T1, the transmission buffer T1 and the ECU 11 are replaced with the transmission buffer T3 and the in-vehicle equipment 13, respectively. In this manner, the first relay processing and the second relay processing of the transmission buffer T3 can be explained.

In the in-vehicle equipment 13, the equipment control unit 33 determines the transmission instruction value based on the calculated entire period so that the determination point in time at which the device control unit 25 of the relay device 10 determines whether or not to transmit the data frame belongs to the open period. The equipment control unit 33 transmits the data frame when the count value of the slave counter 30 is the determined transmission instruction value. For this reason, the relay device 10 quickly transmits the received data frame.

In the first embodiment, the point in time at which the equipment control unit 33 of the in-vehicle equipment 13 gives an instruction to transmit the data frame is adjusted based on the entire period. However, the target to be adjusted based on the entire period may be different from the point in time at which an instruction to transmit the data frame is given.

Hereinafter, the points of a second embodiment that are different from the first embodiment will be described. Since configurations other than those described later are the same as those of the first embodiment, the same components as in the first embodiment are denoted by the same reference numerals as in the first embodiment, and the description thereof will be omitted.

The equipment control unit 33 of the in-vehicle equipment 13 according to the second embodiment executes steps S35 and S36 without executing steps S31 to S34 in the frame transmission processing. A data frame transmission instruction value is set in advance. In addition, the data amount of the data frame transmitted from the equipment communication IC 31 of the in-vehicle equipment 13 is substantially constant. The relay device 10 adjusts the start point in time or length of the open period based on the entire period.

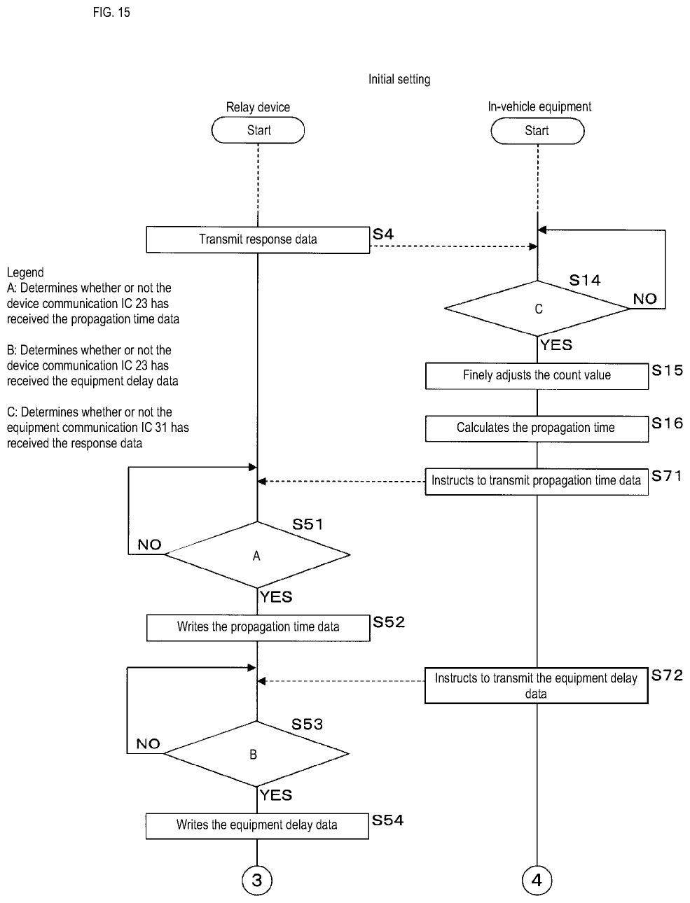

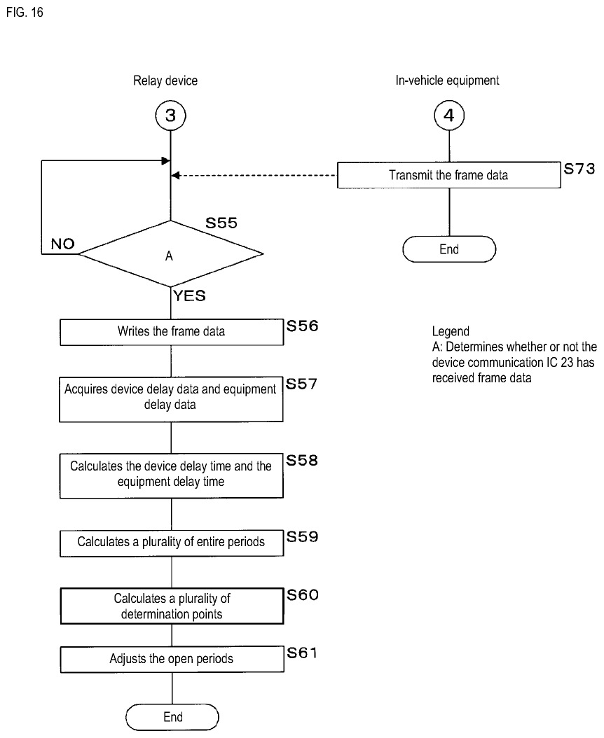

FIGS. 15 and 16 are flowcharts showing the procedure of initial setting performed by the relay device 10 and the in-vehicle equipment 13 according to the second embodiment. In the initial setting of the second embodiment, as in the initial setting of the first embodiment, the device control unit 25 of the relay device 10 and the equipment control unit 33 of the in-vehicle equipment 13 each perform data transmission processing and adjustment processing. In the data transmission processing of the second embodiment, the device control unit 25 of the relay device 10 executes steps S1 to S4 as in the first embodiment. In the adjustment processing of the second embodiment, the equipment control unit 33 of the in-vehicle equipment 13 executes steps S11 to S16 as in the first embodiment.

In the adjustment processing, after executing step S16, the equipment control unit 33 of the in-vehicle equipment 13 instructs the equipment communication IC 31 to transmit propagation time data indicating the propagation delay time calculated in step S16 to the device communication IC 23 of the relay device 10 (step S71). In the data transmission processing, after executing step S4, the device control unit 25 of the relay device 10 determines whether or not the device communication IC 23 has received the propagation time data (step S51). When it is determined that the device communication IC 23 has not received the propagation time data (S51: NO), the device control unit 25 executes step S51 again and waits until the device communication IC 23 receives the propagation time data.

When it is determined that the device communication IC 23 has received the propagation time data (S51: YES), the device control unit 25 writes the propagation time data received by the device communication IC 23 into the device storage unit 24 (step S52). In the adjustment processing, after executing step S71, the equipment control unit 33 of the in-vehicle equipment 13 instructs the equipment communication IC 31 to transmit the equipment delay data stored in the equipment storage unit 32 to the device communication IC 23 of the relay device 10 (step S72). In the data transmission processing, after executing step S52, the device control unit 25 of the relay device 10 determines whether or not the device communication IC 23 has received the equipment delay data (step S53). When it is determined that the device communication IC 23 has not received the equipment delay data (S53: NO), the device control unit 25 executes step S53 again and waits until the device communication IC 23 receives the equipment delay data.

When it is determined that the device communication IC 23 has received the equipment delay data (S53: YES), the device control unit 25 writes the equipment delay data received by the device communication IC 23 into the device storage unit 24 (step S54). In the adjustment processing, after executing step S72, the equipment control unit 33 of the in-vehicle equipment 13 instructs the equipment communication IC 31 to transmit the frame data of the data frame transmitted by the in-vehicle equipment 13 to the device communication IC 23 of the relay device 10 (step S73). The frame data of the data frame transmitted from the in-vehicle equipment 13 is stored in the device storage unit 24 in advance.

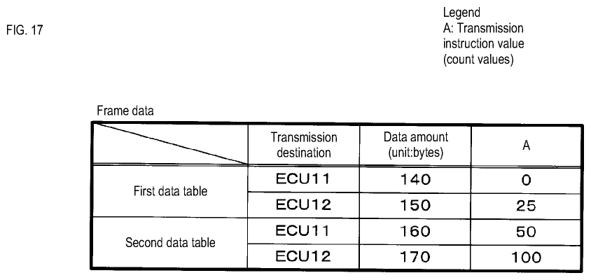

FIG. 17 is a chart showing the contents of frame data. The frame data indicates the data amounts of the first data frame and the second data frame and the transmission instruction values of the first data frame and the second data frame. The transmission instruction value is the count values of the master counter 20 and the slave counter 30 after synchronization is achieved. FIG. 17 shows frame data of a data frame transmitted from the in-vehicle equipment 13.

In the example of FIG. 17, for the first data frame whose transmission destination is the ECU 11, the data amount is 140 bytes and the transmission instruction value is zero. For the first data frame whose transmission destination is the ECU 12, the data amount is 150 bytes and the transmission instruction value is 25. For the second data frame whose transmission destination is the ECU 11, the data amount is 160 bytes and the transmission instruction value is 50. For the second data frame whose transmission destination is the ECU 12, the data amount is 170 bytes and the transmission instruction value is 100.

The contents of the frame data of the data frame transmitted from each of the ECUs 11 and 12 are the same as the contents of the frame data of the data frame transmitted from the in-vehicle equipment 13. For the data frame transmitted from the ECU 11, the ECU 12 and the in-vehicle equipment 13 are transmission destinations. For the data frame transmitted from the ECU 12, the ECU 11 and the in-vehicle equipment 13 are transmission destinations. The frame data of the data frames transmitted from the ECUs 11 and 12 are stored in the device storage unit 24 in advance.

As shown in FIG. 16, the equipment control unit 33 ends the adjustment processing after executing step S73. After the in-vehicle equipment 13 is disconnected from the connector 10a, when the in-vehicle equipment 13 is reconnected to the connector 10a, the equipment control unit 33 performs the adjustment processing again.

In the data transmission processing, after executing step S54, the device control unit 25 of the relay device 10 determines whether or not the device communication IC 23 has received frame data (step S55). When it is determined that the device communication IC 23 has not received the frame data (S55: NO), the device control unit 25 executes step S55 again and waits until the device communication IC 23 receives the frame data. When it is determined that the device communication IC 23 has received the frame data (S55: YES), the device control unit 25 writes the frame data into the device storage unit 24 (step S56).

Then, the device control unit 25 acquires device delay data and equipment delay data from the device storage unit 24 (step S57). Then, based on the device delay data and the equipment delay data acquired in step S57, the device control unit 25 calculates the device delay time and the equipment delay time corresponding to each of a plurality of data amounts indicated by the frame data (step S58). Here, the plurality of data amounts are the data amounts of the first data frame and the second data frame whose transmission destination is the ECU 11 and the data amounts of the first data frame and the second data frame whose transmission destination is the ECU 12.

Then, the device control unit 25 calculates a plurality of entire periods based on the propagation time indicated by the propagation time data and the device delay time and the equipment delay time calculated in step S58 (step S59). Here, the plurality of entire periods are the entire period of the first data frame and the second data frame whose transmission destination is the ECU 11 and the entire period of the first data frame and the second data frame whose transmission destination is the ECU 12. After executing step S59, the device control unit 25 calculates a plurality of determination points in time based on the plurality of transmission instruction values indicated by the frame data and the plurality of entire periods calculated in step S59 (step S60). Here, the plurality of determination points in time are the determination points in time for the first data frame and the second data frame whose transmission destination is the ECU 11 and the determination points in time for the first data frame and the second data frame whose transmission destination is the ECU 12.

It is assumed that the width of the count value obtained by dividing the entire period of the first data frame whose transmission destination is the ECU 11 by a predetermined period is 50. In the example of FIG. 17, the transmission instruction value of the first data frame whose transmission destination is the ECU 11 is zero. In this case, the determination point in time for the first data frame whose transmission destination is the ECU 11 is 50 (=0+50).

Then, the device control unit 25 adjusts the open periods of the first queue Q1 and the second queue Q2 of the transmission buffers T1 and T2 based on the plurality of determination points in time calculated in step S60 (step S61). The adjustment of the open period is an adjustment of the start point in time or length of the open period. In one cycle, a period other than the open period is a close period. Therefore, when the start point in time and length of the open period are determined, the start point in time and length of the close period are automatically determined. Each of the ECUs 11 and 12 transmits the first data frame or the second data frame when the count value of the slave counter 30 is the transmission instruction value indicated by the frame data.

In step S61, the device control unit 25 adjusts, for the transmission buffer T1, the start point in time or length of the open period of the first queue Q1 so that the determination points in time for all the first data frames whose transmission destination is the ECU 11 belong to the open period of the first queue Q1. In addition, the device control unit 25 adjusts, for the transmission buffer T1, the start point in time or length of the open period of the second queue Q2 so that the determination points in time for all the second data frames whose transmission destination is the ECU 11 belong to the open period of the second queue Q2. In addition, the device control unit 25 adjusts the start point in time or length of the open period of each of the first queue Q1 and the second queue Q2 of the transmission buffer T2 in the same manner as the start point in time or length of the open period of each of the first queue Q1 and the second queue Q2 of the transmission buffer T1.

After executing step S61, the device control unit 25 ends the data transmission processing. When the in-vehicle equipment 13 is disconnected from the connector 10a, the device control unit 25 performs the data transmission processing again.

### <Effects of the Communication System 1>

As described above, in the relay device 10, the device control unit 25 adjusts the start point in time or length of the open period of each of the first queue Q1 and the second queue Q2 for each of the transmission buffers T1 and T2. Therefore, the relay device 10 quickly transmits the data frame received from the in-vehicle equipment 13 to the ECU 11 or the ECU 12.

The communication system 1 according to the second embodiment similarly has other effects except for the effects obtained by the equipment control unit 33 of the in-vehicle equipment 13 determining the transmission instruction value based on the entire period, among the effects of the communication system 1 according to the first embodiment.

In the first embodiment, the equipment control unit 33 of the in-vehicle equipment 13 uses the data amount of the data frame in calculating the entire period. However, the equipment control unit 33 may use other numerical values in addition to the data amount of the data frame in calculating the entire period.

Hereinafter, the points of the third embodiment that are different from the first embodiment will be described. Since configurations other than those described later are the same as those of the first embodiment, the same components as in the first embodiment are denoted by the same reference numerals as in the first embodiment, and the description thereof will be omitted.

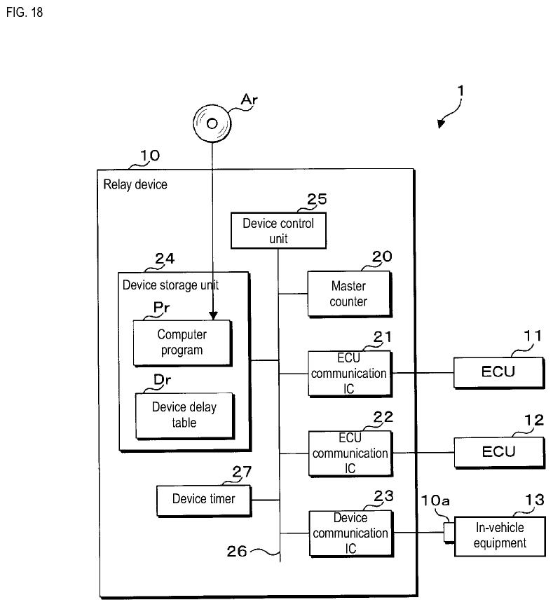

FIG. 18 is a block diagram showing the main configuration of the relay device 10 according to the third embodiment. The relay device 10 according to the third embodiment has a device timer 27 in addition to the components of the relay device 10 according to the first embodiment. The device timer 27 is connected to the device bus 26. The device timer 27 measures a device elapsed time that has passed from the manufacturing of the relay device 10. The device elapsed time measured by the device timer 27 is read by the device control unit 25.

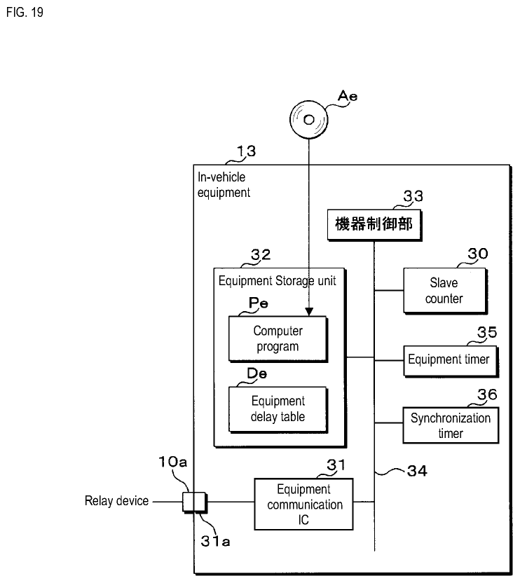

FIG. 19 is a block diagram showing the main configuration of the in-vehicle equipment 13. The in-vehicle equipment 13 according to the third embodiment has an equipment timer 35 and a synchronization timer 36 in addition to the components of the in-vehicle equipment 13 according to the first embodiment. The equipment timer 35 and the synchronization timer 36 are connected to the equipment bus 34. The equipment timer 35 measures an equipment elapsed time that has passed from the manufacturing of the in-vehicle equipment 13. The equipment elapsed time measured by the equipment timer 35 is read by the equipment control unit 33.

The synchronization timer 36 measures time. The measurement time measured by the synchronization timer 36 is synchronized with the device elapsed time measured by the device timer of the relay device 10. After synchronization is achieved, the measurement time of the synchronization timer 36 is the device elapsed time. The measurement time of the synchronization timer 36 is read by the equipment control unit 33.

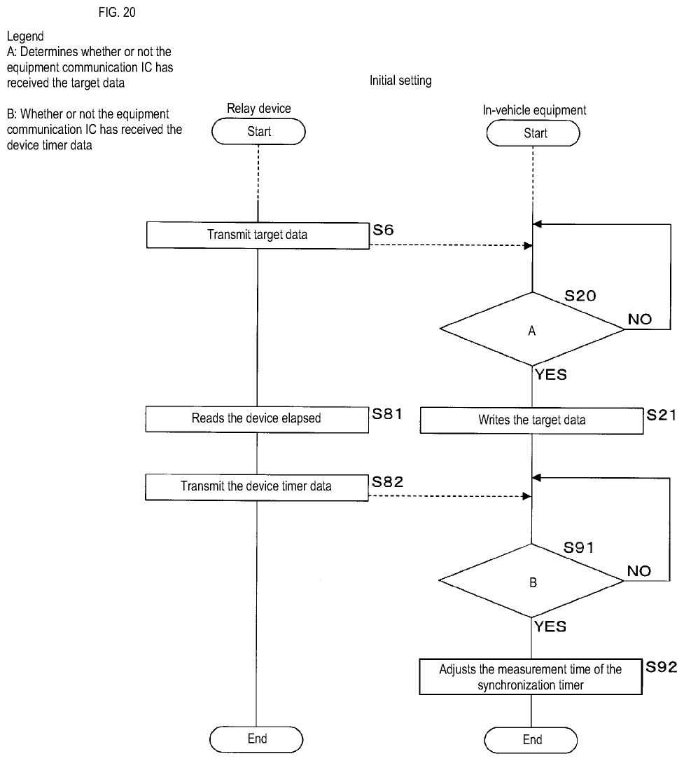

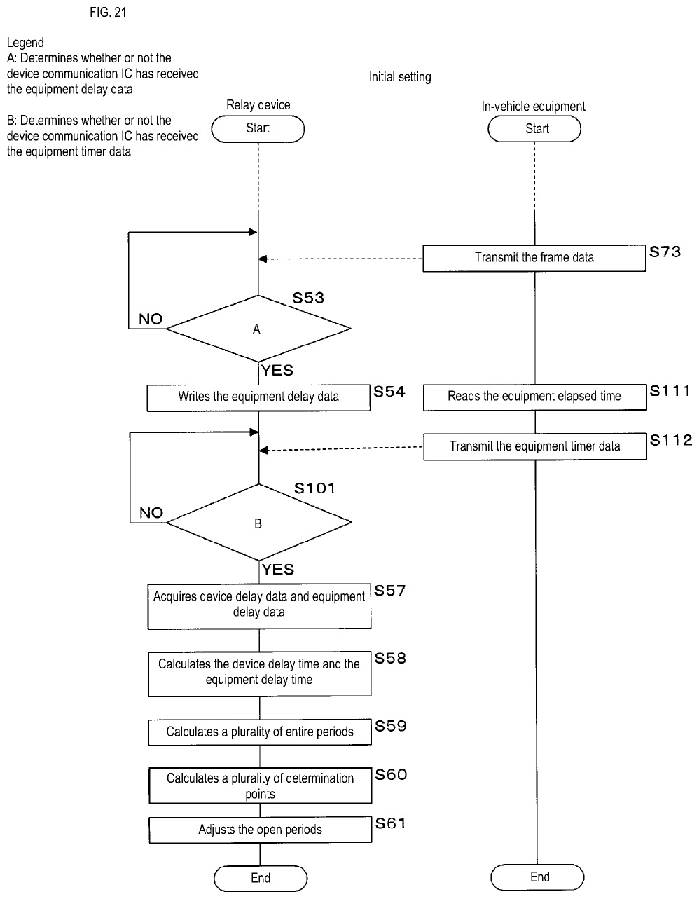

FIG. 20 is a flowchart showing the procedure of initial setting performed by the relay device 10 and the in-vehicle equipment 13. In the initial setting of the third embodiment, as in the initial setting of the first embodiment, the device control unit 25 of the relay device 10 and the equipment control unit 33 of the in-vehicle equipment 13 each perform data transmission processing and adjustment processing. In the data transmission processing of the third embodiment, the device control unit 25 of the relay device 10 executes steps S1 to S6 as in the first embodiment. In the adjustment processing of the third embodiment, the equipment control unit 33 of the in-vehicle equipment 13 executes steps S11 to S21 as in the first embodiment.

In the data transmission processing, after executing step S6, the device control unit 25 of the relay device 10 reads the device elapsed time measured by the device timer 27 (step S81). Then, the device control unit 25 instructs the device communication IC 23 to transmit the device timer data indicating the device elapsed time read in step S81 to the equipment communication IC 31 of the in-vehicle equipment 13 (step S82). After executing step S82, the device control unit 25 ends the data transmission processing. When the in-vehicle equipment 13 is disconnected from the connector 10a, the device control unit 25 performs the data transmission processing again.

In the adjustment processing, after executing step S21, the equipment control unit 33 determines whether or not the equipment communication IC 31 has received the device timer data (step S91). When it is determined that the equipment communication IC 31 has not received the device timer data (S91: NO), the equipment control unit 33 executes step S91 again and waits until the equipment communication IC 31 receives the device timer data.

When it is determined that the equipment communication IC 31 has received the device timer data (S91: YES), the equipment control unit 33 adjusts the measurement time of the synchronization timer 36 to the device elapsed time indicated by the device timer data (step S92). As a result, the measurement time of the synchronization timer 36 is synchronized with the device elapsed time measured by the device timer 27. After executing step S92, the equipment control unit 33 ends the adjustment processing. After the in-vehicle equipment 13 is disconnected from the connector 10a, when the in-vehicle equipment 13 is reconnected to the connector 10a, the equipment control unit 33 performs the adjustment processing again.

The device delay data in the third embodiment indicates the device delay time corresponding to the data amount of the data frame transmitted to the relay device 10 and the device elapsed time. Specifically, the device delay data indicates a functional expression for calculating the device delay time based on the data amount and the device elapsed time. The acquisition of the device delay data corresponds to the acquisition of the device delay time associated with the data amount of the data frame and the device elapsed time.

The equipment delay data in the third embodiment indicates the equipment delay time corresponding to the data amount of the data frame transmitted to the relay device 10 and the equipment elapsed time. Specifically, the equipment delay data indicates a functional expression for calculating the equipment delay time based on the data amount and the equipment elapsed time. The acquisition of the equipment delay data corresponds to the acquisition of the equipment delay time associated with the data amount of the data frame and the equipment elapsed time.

In step S32 of the frame transmission processing in the third embodiment, the equipment control unit 33 calculates a device delay time and an equipment delay time based on the device delay data and the equipment delay data acquired in step S31. In step S33, the equipment control unit 33 calculates a device delay time corresponding to the data amount of the data frame stored in the equipment storage unit 32 and the equipment elapsed time of the equipment timer 35. In addition, the equipment control unit 33 calculates an equipment delay time corresponding to the data amount of the data frame stored in the equipment storage unit 32 and the measurement time (device delay time) of the synchronization timer 36. In step S33, the equipment control unit 33 calculates an entire period by using the device delay time and the equipment delay time calculated in step S32.

Each of the ECUs 11 and 12 is configured similarly to the in-vehicle equipment 13. Each of the ECUs 11 and 12 transmits data frames in the same manner as the in-vehicle equipment 13.

In the entire period calculated by the equipment control unit 33 in the in-vehicle equipment 13, the device elapsed time and the equipment elapsed time, that is, deterioration over time, is taken into consideration. Therefore, the equipment control unit 33 calculates a transmission instruction value whose determination point in time reliably belongs to the open period.

The communication system 1 according to the third embodiment has the same effects as those of the communication system 1 according to the first embodiment.

In the second embodiment, the device control unit 25 of the relay device 10 uses the data amount of the data frame in calculating the entire period. However, the device control unit 25 may use other numerical values in addition to the data amount of the data frame in calculating the entire period.

Hereinafter, the points of a fourth embodiment that are different from the second embodiment will be described. Since configurations other than those described later are the same as those of the second embodiment, the same components as in the second embodiment are denoted by the same reference numerals as in the second embodiment, and the description thereof will be omitted.

The relay device 10 according to the fourth embodiment has a device timer 27 as in the third embodiment, in addition to the components of the relay device 10 according to the second embodiment.

### <Configuration of the In-Vehicle Equipment 13>

The in-vehicle equipment 13 according to the fourth embodiment has an equipment timer 35 as in the third embodiment, in addition to the components of the in-vehicle equipment 13 according to the second embodiment.

FIG. 21 is a flowchart showing the procedure of initial setting performed by the relay device 10 and the in-vehicle equipment 13 according to the fourth embodiment. In the initial setting of the fourth embodiment, as in the initial setting of the second embodiment, the device control unit 25 of the relay device 10 and the equipment control unit 33 of the in-vehicle equipment 13 each perform data transmission processing and adjustment processing. In the data transmission processing of the fourth embodiment, steps S1 to S4 and S51 to S61 are executed as in the second embodiment. In the adjustment processing of the fourth embodiment, steps S11 to S16 and S71 to S73 are executed as in the second embodiment.

In the adjustment processing, after executing step S73, the equipment control unit 33 of the in-vehicle equipment 13 reads the equipment elapsed time measured by the equipment timer 35 (step S111). Then, the equipment control unit 33 instructs the equipment communication IC 31 to transmit the equipment timer data indicating the equipment elapsed time read in step S111 to the device communication IC 23 of the relay device 10 (step S112). After executing step S112, the device control unit 25 ends the data transmission processing. When the in-vehicle equipment 13 is disconnected from the connector 10a, the device control unit 25 performs the data transmission processing again.

In the data transmission processing, after executing step S54, the device control unit 25 of the relay device 10 determines whether or not the device communication IC 23 has received the equipment timer data (step S101). When it is determined that the device communication IC 23 has not received the equipment timer data (S101: NO), the device control unit 25 executes step S101 again and waits until the device communication IC 23 receives the equipment timer data.

When it is determined that the device communication IC 23 has received the equipment timer data (S101: YES), the device control unit 25 executes step S57. The device delay data and the equipment delay data in the fourth embodiment are the same as the device delay data and the equipment delay data in the third embodiment, respectively.

In step S58 of the data transmission processing in the fourth embodiment, based on the device delay data and the equipment delay data acquired in step S57, the device control unit 25 calculates the device delay time and the equipment delay time corresponding to each of the plurality of data amounts indicated by the frame data. Each of the plurality of device delay times calculated in step S58 also corresponds to the device elapsed time of the device timer 27. Each of the plurality of equipment delay times calculated in step S58 also corresponds to the equipment elapsed time indicated by the equipment timer data. In step S59, the device control unit 25 calculates a plurality of entire periods based on the device delay time and the equipment delay time calculated in step S58.

In step S60 of the data transmission processing, the relay device 10 calculates a plurality of accurate determination points in time for which not only the data amount of the data frame but also the device elapsed time and the equipment elapsed time, that is, deterioration over time, is taken into consideration. Therefore, in step S61, the device control unit 25 appropriately adjusts the start point in time or length of the open period.

The communication system 1 according to the fourth embodiment has the same effects as those of the communication system 1 according to the second embodiment.

After the in-vehicle equipment 13 is connected to the connector 10a, the equipment control unit 33 of the in-vehicle equipment 13 may execute steps S111 and S112 each time a predetermined period, for example, one year, passes. In this case, the device control unit 25 of the relay device 10 executes steps S101 and S57 to S61.

In the first to fourth embodiments, the device communication IC 23 has processing elements that perform processing. The device communication IC 23 may perform some of the above-described processes performed by the device control unit 25 instead of the device control unit 25. In this case, both the device communication IC 23 and the device control unit 25 or the device communication IC 23 functions as a processing unit. Similarly, the equipment communication IC 31 has processing elements that perform processing. The equipment communication IC 31 may execute some or all of the above-described processes performed by the equipment control unit 33 instead of the equipment control unit 33. In this case, both the equipment communication IC 31 and the equipment control unit 33 or the equipment communication IC 31 functions as a processing unit.

Each of the ECUs 11 and 12 and the in-vehicle equipment 13 may transmit a plurality of first data frames during the open period of the first queue Q1. Similarly, each of the ECUs 11 and 12 and the in-vehicle equipment 13 may transmit a plurality of second data frames during the open period of the second queue Q2. The processing performed when the determination point in time belongs to the close period is not limited to discarding the data frame, and may be suspending the transmission of the data frame. In this case, for example, no data frame is transmitted until the next open period arrives. When the next open period arrives, a data frame whose transmission was pending is transmitted.

The number of queues provided in each of the transmission buffers T1, T2, and T3 is not limited to two, and may be three or more. The number of ECUs connected to the relay device 10 is not limited to two, and may be three or more. The number of pieces of in-vehicle equipment 13 connected to the relay device 10 may be two or more. The number of reception buffers and the number of transmission buffers are the same as the total number of ECUs and pieces of in-vehicle equipment 13 connected to the relay device 10.

In the first and second embodiments, there is no problem if the device delay data indicates the device delay time corresponding to the data amount. Therefore, the contents indicated by the device delay data are not limited to the functional expression for calculating the device delay time based on the data amount, and may be, for example, a table showing the relationship between the data amount and the device delay time. Similarly, there is no problem if the equipment delay data indicates the equipment delay time corresponding to the data amount. Therefore, the contents indicated by the equipment delay data are not limited to the functional expression for calculating the equipment delay time based on the data amount, and may be, for example, a table showing the relationship between the data amount and the equipment delay time. If the data amount of the data frame transmitted from the in-vehicle equipment 13 is fixed, the device delay data may indicate a predetermined device delay time. In a similar case, the equipment delay data may indicate a predetermined equipment delay time.

In the third and fourth embodiments, there is no problem if the device delay data indicates the device delay time corresponding to the data amount and the device elapsed time. Therefore, the contents indicated by the device delay data are not limited to the functional expression for calculating the device delay time based on the data amount and the device delay time, and may be, for example, a table showing the relationship among the data amount, the device delay time, and the device delay time. Similarly, there is no problem if the equipment delay data indicates the equipment delay time corresponding to the data amount and the equipment elapsed time. Therefore, the contents indicated by the equipment delay data are not limited to the functional expression for calculating the equipment delay time based on the data amount and the equipment elapsed time, and may be, for example, a table showing the relationship among the data amount, the equipment elapsed time, and the equipment delay time.

It should be considered that the first to fourth embodiments disclosed are examples in all points and not restrictive. The scope of the present disclosure is defined by the claims rather than the meanings set forth above, and is intended to include all modifications within the scope and meaning equivalent to the claims.

1. A communication device mounted in a vehicle to transmit data to a relay device for transmitting received data, comprising:
a processing circuit that performs processing,
wherein the processing circuit gives an instruction for data transmission to the relay device, acquires a transmission delay time from the instruction for data transmission to transmission of the data, acquires, from the relay device, a determination delay time from reception of the data by the relay device to a determination point in time at which whether or not to transmit the received data is determined, and calculates an entire period from the instruction for data transmission to the determination point in time based on the acquired transmission delay time in the communication device and the acquired determination delay time in the relay device.

2. The communication device according to claim 1, wherein a permitted period during which transmission of the received data is permitted and a prohibited period during which transmission of the received data is prohibited are alternately set repeatedly.

3. The communication device according to claim 2, wherein the processing circuit determines a point in time for giving an instruction for data transmission based on the calculated entire period.

4. The communication device according to claim 1, wherein the processing circuit calculates a propagation time from data transmission to data reception, and calculates the entire period based on the acquired transmission delay time and determination delay time and the calculated propagation time.

5. The communication device according to claim 1, wherein the processing circuit acquires the transmission delay time and the determination delay time associated with a data amount of data to be transmitted to the relay device.

6. A relay device mounted in a vehicle to transmit data received from a communication device, comprising:
a receiving circuit that receives data from the communication device; and
a processing circuit that performs processing,
wherein the processing circuit determines whether or not to transmit the data received by the receiving circuit when the receiving circuit receives the data, acquires, from the communication device, a transmission delay time from when the communication device is instructed to transmit the data to when the data is transmitted, acquires a determination delay time from when the receiving circuit receives the data to a determination point in time at which whether or not to transmit the received data is determined, and calculates an entire period from when the communication device is instructed to transmit the data to the determination point in time based on the acquired transmission delay time in the communication device and the acquired determination delay time in the relay device.

7. The relay device according to claim 6, wherein a permitted period during which transmission of the data received by the receiving circuit is permitted and a prohibited period during which transmission of the data received by the receiving circuit is prohibited are alternately set repeatedly, and
when the determination point in time belongs to the permitted period, the processing circuit determines that the data received by the receiving circuit is to be transmitted.

8. The relay device according to claim 7, wherein the processing circuit calculates a determination point in time for the data received by the receiving circuit based on the calculated entire period, and adjusts a start point in time or length of the permitted period based on the calculated determination point in time.

9. A communication method for performing data communication, the method causing a computer mounted in a vehicle to execute:
a step of acquiring a transmission delay time from when a communication device is instructed to transmit data to a relay device for transmitting received data to when the data is transmitted; a step of acquiring a determination delay time from reception of the data by the relay device to a determination point in time at which whether or not to transmit the received data is determined; and
a step of calculating an entire period from the instruction for data transmission to the determination point in time based on the acquired transmission delay time in the communication device and the acquired determination delay time in the relay device.

10. The communication device according claim 2, wherein the processing circuit calculates a propagation time from data transmission to data reception, and calculates the entire period based on the acquired transmission delay time and determination delay time and the calculated propagation time.

11. The communication device according claim 3, wherein the processing circuit calculates a propagation time from data transmission to data reception, and calculates the entire period based on the acquired transmission delay time and determination delay time and the calculated propagation time.

12. The communication device according claim 2, wherein the processing circuit acquires the transmission delay time and the determination delay time associated with a data amount of data to be transmitted to the relay device.

13. The communication device according claim 3, wherein the processing circuit acquires the transmission delay time and the determination delay time associated with a data amount of data to be transmitted to the relay device.

14. The communication device according claim 4, wherein the processing circuit acquires the transmission delay time and the determination delay time associated with a data amount of data to be transmitted to the relay device.
